(19) United States
(12) Patent Application Publication
(10) Pub. No.: US 2017/0146128 A1
(43) Pub. Date: May 25, 2017

(54) MECHANICAL SEAL FOR IMPROVING THE EFFECTIVENESS OF CLAMPING WHEN FITTED TO A HARDENED SHAFT

(71) Applicant: Andrew Parkin, Rotherham (GB)

(72) Inventor: Andrew Parkin, Rotherham (GB)

(73) Assignee: AES Engineering Ltd., Rotherham (GB)

(21) Appl. No.: 15/356,610

(22) Filed: Nov. 20, 2016

(30) Foreign Application Priority Data
Nov. 19, 2015 (GB) 1520392.0

(51) Int. Cl. F16J 15/28

(52) U.S. Cl. CPC F16J 15/28

(57) ABSTRACT

A mechanical seal includes a sleeve in sealing engagement with a rotating shaft of a piece of equipment and one or more primary or secondary sealing faces urged toward one another by a plurality of spring members. A gland detachably attached to a housing of the piece of equipment. A clamp ring is provided with one or more setting members detachably attached to the clamp ring and the gland to restrict axial and rotational movement and to render internal dimensions independent of the tolerances and assembly accuracy of the piece of equipment.

### BACKGROUND OF THE INVENTION

Technical Field of the Invention

The invention relates to a mechanical seal, which improves the effectiveness of clamping when fitted to a hardened shaft.

Description of the Prior Art

Mechanical seals are common place in a multitude of industries for providing a seal between rotating and stationary components. The seal is created by one sealing face rotating against a stationary sealing face.

Commonly, when used with hardened shafts clamping with the conventional grub screw arrangement, the result can lead to slipping both axially down the shaft and rotationally around the shaft. Slipping of the cartridge can cause a loss of rotational drive within the rotary section of the mechanical seal. If the clamping force isn't sufficiently substantial, axial slipping can also occur which can change the face pressure of the seal. Both issues can result in seal failure.

As a result, a Graphoil wedge is integrated within the present invention in order to suit high temperature applications and overcome the known drawbacks inherent in the prior art. An axial and radial force is then applied to the wedge in order hold it in place.

### SUMMARY OF THE INVENTION

It is therefore an object of the present invention to provide a mechanical seal which improves the effectiveness of clamping when fitted to a hardened shaft, which avoids slippage, both axially down the shaft as well as rotationally around the shaft.

The foregoing and related objects are accomplished by the mechanical seal of the present invention, which includes, in a preferred embodiment, a sleeve that is in a sealing engagement with a rotating shaft and one or more primary or secondary sealing faces urged toward one another via a plurality of spring members. A clamping ring which has a plurality of radial orifices in which are located a plurality of set screws extending from the inner diameter to the outer diameter of the clamping ring. One or more gland members are detachably attached to the clamping ring for restricting axial movement and rendering the internal dimensions independent of tolerances and assembly accuracy of the piece of equipment having the hardened shaft, along with a two-part clamping ring which is comprised of a plurality of protrusions axially extending the length of the clamping ring and which can be forced on via grub screws for inhibiting axial and rotary movement of the gland members, and with an axial cavity being located in the sleeve for minimizing surface contact on the shaft.

It is preferable that the gland members extend the entire length of the mechanical seal, thereby encasing the seal.

It is also preferable that the one or more gland members have orifices through which a fluid connection is achieved between an external port and the internal cavities of the mechanical seal.

Preferably, a rotary labyrinthine profiled component is detachably attached to the sleeve.

The clamp ring assembly may comprise a first member creating a platform onto which grub screws are tightened, a second member containing one or more threaded orifices wherein set screws reside and a third member which is located in an annular cavity between the sleeve and the shaft.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 shows a cross-sectional view of a solution known to the prior art;

FIG. 2 shows a “Detail A” of FIG. 1;

FIG. 3 shows “Detail A” of FIG. 1 in an alternative axial cross-sectional view;

FIG. 4 shows the present invention in relationship to “Detail A” of FIG. 1; and,

FIG. 5 shows the present invention in relation to “Detail A” in an alternative axial cross-sectional view.

### DETAILED DESCRIPTION OF THE DRAWING FIGURES AND PREFERRED EMBODIMENTS

The invention will now be described, by way of example only, with reference to the accompanying drawings:

As shown in FIG. 1, a mechanical seal, A, is used in high-temperature applications to create a seal which prevents the process fluid from substantially leaking, which is achieved through the rotary seal face 1 and the stationary seal face 2, thereby creating a fluid film. Face pressure is accurately applied via a spring 3, with the prior art clamping solution, B, clamping onto a hardened shaft, C.

As shown in FIG. 2, a known solution for the mechanical seal is shown, wherein the mechanical seal, A, is axially constrained in a horizontal orientation on the shaft.

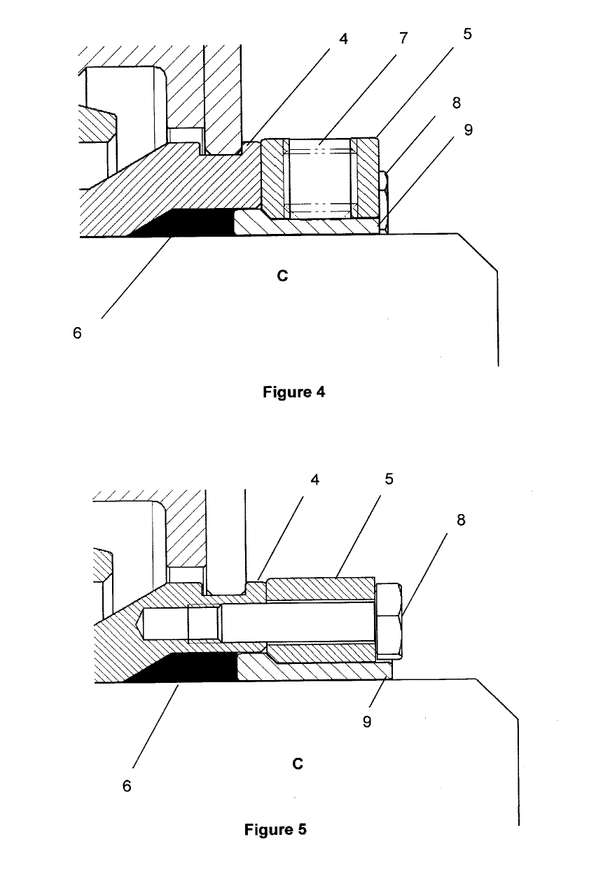

In sharp contrast to the prior art, a preferred embodiment of the present invention, as shown in FIG. 4, has all components axially constrained by means of a detachable clamping ring 9. A grub screw housing 5 fits over the clamping ring 9 to house the grub screws 7.

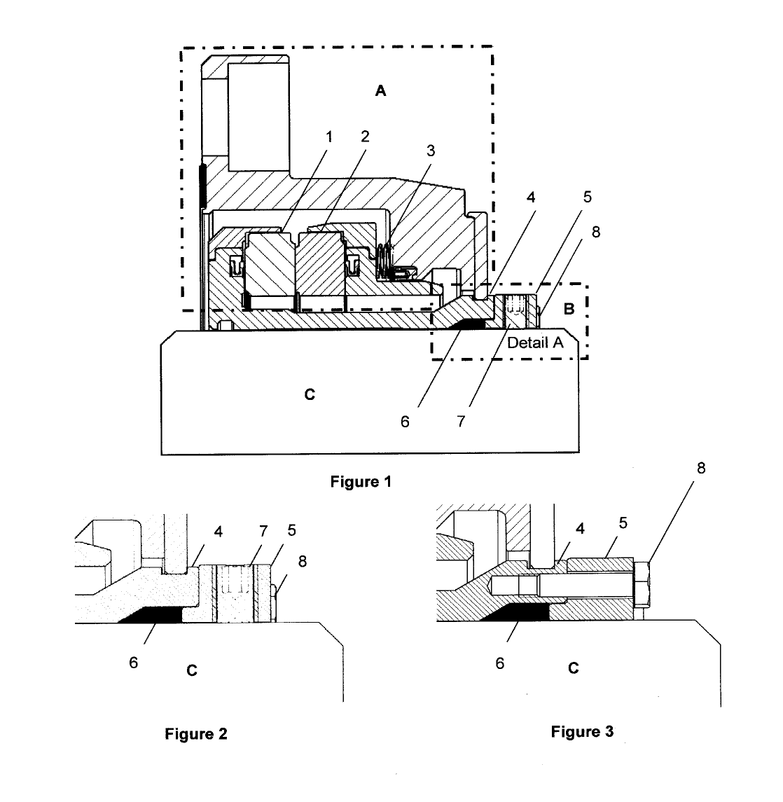

As shown in FIG. 5, fixing screws 8 clamp together the grub screw housing 5 with the sleeve 4. This procedure of clamping is constant with the prior art, which is shown in an alternate axial cross sectional view in FIG. 3.

The Graphoil wedge 6 is held as a result in place by the clamping ring 9 and the sleeve 4.

While only several embodiments of the present invention have been shown and described, it will be obvious to those skilled in the art that many modifications may be made to the present invention without departing from the spirit and scope thereof.

What is claimed is:

1. A mechanical seal, comprising:
a sleeve in sealing engagement with a rotating shaft of a piece of equipment;
one or more primary or secondary sealing faces urged toward one another via a plurality of spring members;
a gland detachably attached to a housing of the piece of equipment;
a clamp ring; and, one or more setting members detachably attached to said clamp ring and said gland, thereby restricting axial and rotational movement and rendering internal dimensions independent of the tolerances and assembly accuracy of the piece of equipment.

2. The mechanical seal according to claim 1, wherein said clamp ring includes a first setting member creating a platform onto which grub screws are tightened, a second setting member having one or more threaded orifices, wherein set screws reside, and a setting third member located in an annular cavity between said sleeve and the rotating shaft of the piece of equipment.

3. The mechanical seal according to claim 2, wherein said clamp ring has one or more radially inwardly protruding setting members securely fastened to said first setting member and axially interlocking with said second setting member.

4. The mechanical seal according to claim 2, wherein said second setting member of said clamp ring is axially connected to said sleeve via one or more threaded fasteners.

5. The mechanical seal according to claim 2, wherein said sleeve is held onto the rotating shaft via a radial force applied through a tightening of grub screws onto the first setting member.

6. The mechanical seal according to claim 1, further comprising a plurality of radial clamps for providing axial and rotary locking.

7. The mechanical seal according to claim 1, further comprising a Graphoil wedge creating a seal between said sleeve and the rotating shaft of the piece of equipment.

8. The mechanical seal according claim 7, wherein said clamp ring includes a first setting member creating a platform onto which grub screws are tightened, a second setting member having one or more threaded orifices, wherein set screws reside, and a third setting member located in an annular cavity between said sleeve and the rotating shaft of the piece of equipment, said Graphoil wedge creating a low coefficient of friction between said first setting member and said sleeve.

9. The mechanical seal according to claim 7, said Graphoil wedge includes an angled profile for providing squeeze between said Graphoil wedge and the rotating shaft of the piece of equipment.

10. The mechanical seal according to claim 2, further comprising a stepped interface between said first setting member and said second setting member of differing diameters of said clamp ring.

11. The mechanical seal according to claim 10, wherein said stepped interface generates both an axial and radial load on said clamp ring.
